(19) United States
(12) Patent Application Publication
(10) Pub. No.: US 2019/0323846 A1
(43) Pub. Date: Oct. 24, 2019

(54) METHOD AND SYSTEM FOR SYSTEMATIC CONTIGUOUS ENCODING OF NETWORK OF ROADS IN A GEOGRAPHICAL AREA

(71) Applicant: ZIPPR PRIVATE LIMITED, Hyderabad, Telangana (IN)

(72) Inventors: Krishna Kishore DHARA, Hyderabad (IN); Aditya VUCHI, Hyderabad (IN); Muralidhar Raju KANCHANAPALLI, Hyderabad (IN); Gadam Setti THRIVIKRAM, Kurnool (IN)

(73) Assignee: ZIPPR PRIVATE LIMITED, Hyderabad, Telangana (IN)

(21) Appl. No.: 16/475,511

(22) PCT Filed: Aug. 23, 2017
(86) PCT No.: PCT/IB2017/055080

§ 371 Date: Jul. 2, 2019

(30) Foreign Application Priority Data
Aug. 24, 2016 (IN) 201641028810

(51) Int. Cl. G01C 21/32; G06F 16/29; G06F 16/28

(52) U.S. Cl. CPC G01C 21/32; G06F 16/285; G06F 16/29

(57) ABSTRACT

A method and a system for systematic encoding of network of roads in a geographical area retrieves road data of the network of roads from one or more data sources and normalizes the road data to divide each road based on predefined first parameters. Thereafter, the encoding system divides the geographical area including the network of roads into clusters based on predefined second parameters. Now, the encoding system selects a major road in each of the clusters and creates sub-clusters from the clusters until the major road satisfies certain limits such as a first limit and a second limit. Finally, the encoding system encodes each major road and the corresponding incident roads contiguously or near contiguously in accordance with the clusters such that the encoding is contiguous, systematic and accurate.

### TECHNICAL FIELD

The present subject matter is related in general to encoding, and more particularly, but not exclusively to a method and a system for systematic contiguous encoding of a network of roads in a geographical area.

### BACKGROUND

Encoding is a process of arranging a sequence of characters such as letters, numbers, punctuation and symbols into a specialized format. Encoding of a geographical area is nothing but assigning a particular sequence of characters to each of one or more entities in the geographical area. The particular sequence of characters may indicate accurate location of each of the one or more entities and help in easy identification of each of the one or more entities.

Currently, most encoding systems are based on Global Positioning System (GPS). The GPS provides latitude and longitude (also referred as lat-long) information of the one or more entities in the geographical area. Few other encoding systems work on a micro-level street numbering system. Generally, in the GPS based system, a code is generated using lat-long or geo-coordinates of one or more entities like a dwelling in the geographical area. The lat-long is encoded in a numeric or an alpha-numeric code. There are many techniques used in the GPS based encoding systems such as grid based technique, geo-hash based technique etc. The goal of these GPS based encoding systems is to provide navigation. The GPS based encoding systems when associated with a navigation system provide routes for a location, expected time to reach a location, alternate routes for a location, traffic conditions along the route and other related features to reach the dwelling.

At present, even though the GPS based encoding systems are extensively used, there are various issues that are associated with the GPS based encoding systems. The first issue is that dwellings on a street mostly do not get contiguous encoding since many cities, towns, municipalities in the world do not have roads that perfectly align with the lat-long provided by the GPS. Therefore, encoding based on lat-long may not be a correct method for cities, towns, and municipalities. Secondly, the GPS based encoding systems do not guarantee any order for incident roads of a main road. Ordered encoding of incident roads is essential for administrative purposes of the Municipality, for city planning, for delivery of civil services, etc. which is not fulfilled by the GPS based encoding systems. Thirdly, the GPS based encoding systems cannot be used for proper signage along the roads to indicate how dwellings can be located locally. Further, another issue is that most of the civic amenities and the physical structures driving a city, town, municipality etc. such as water and electricity connections, tax collection, postal delivery sorting etc. fall along the road contours and are not related to the lat-long of dwellings along the road. Therefore, any encoding system based on lat-long encoding does not work for digital encoding of cities, towns, municipalities, etc. There are a few innovative dwelling encodings based on roads and not based on lat-long. However, all these systems focus on numbering or encoding dwellings on a street that are often very long streets and that cut across multiple zip codes or municipalities. They are restricted to looking at one street at a time and do not consider encoding from a city wide road network and the encoding of the roads incident (at a multi-level) to a street as a whole. Further, these systems do not focus on enabling future growth or future development of dwellings and incident roads. Also, the existing encoding systems do not focus on avoiding or reducing roads incident to more than one major road, also known as creeps, in network of roads.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure comprises a method for systematic contiguous encoding of a network of roads in a geographical area. The method comprises extracting by an encoding system road data related to the network of roads from one or more data sources, wherein the road data is normalized by the encoding system. Upon extracting the road data, the encoding system divides each road in the network of roads based on one or more predefined first parameters such that each road in the network of roads adheres to a first limit determined using one or more predefined first techniques. The first limit indicates predefined number of dwellings in each road in the network of roads. Further, the encoding system groups the divided roads into one or more clusters based on one or more predefined second parameters, wherein the one or more clusters do not overlap. Furthermore, the encoding system identifies a major road in each of the one or more clusters based on one or more predefined third parameters, wherein each of the one or more clusters comprises not more than one major road. Upon identifying the major road, the encoding system verifies adherence of the identified major road in each of the one or more clusters to a second limit determined using one or more predefined second techniques. The second limit indicates predefined number of incident roads of the identified major road in each of the one or more clusters. Further, the encoding system verifies adherence of each of first-level incident roads of the identified major road in each of the one or more clusters to the second limit. Finally, the encoding system performs the systematic contiguous encoding of each of the one or more clusters, the identified major road in each of the one or more clusters and the incident roads of the identified major road in each of the one or more clusters, if the verification is successful.

Further, the present disclosure comprises an encoding system for systematic contiguous encoding of a network of roads in a geographical area. The encoding system comprises a processor and a memory communicatively coupled to the processor. The memory stores the processor-executable instructions, which, on execution, causes the processor to extract road data related to the network of roads from one or more data sources, wherein the road data is normalized by the encoding system. Upon extracting the road data, the processor divides each road in the network of roads based on one or more predefined first parameters such that each road in the network of roads adheres to a first limit determined using one or more predefined first techniques. The first limit indicates predefined number of dwellings in each road in the network of roads. Further, the processor groups the divided roads into one or more clusters based on one or more predefined second parameters, wherein the one or more clusters do not overlap. Furthermore, the processor identifies a major road in each of the one or more clusters based on one or more predefined third parameters, wherein each of the one or more clusters comprises not more than one major road. Upon identifying the major road, the processor verifies adherence of the identified major road in each of the one or more clusters to a second limit determined using one or more predefined second techniques. The second limit indicates predefined number of incident roads of the identified major road in each of the one or more clusters. Further, the processor verifies the adherence of each of first-level incident roads of the identified major road in each of the one or more clusters to the second limit. Finally, the processor performs the systematic contiguous encoding of each of the one or more clusters, the identified major road in each of the one or more clusters and the incident roads of the identified major road in each of the one or more clusters, if the verification is successful.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1A shows an exemplary representation of an encoding system for systematic encoding of network of roads in a geographical area in accordance with some embodiments of the present disclosure;

FIG. 1B shows an exemplary representation of network of roads in accordance with some embodiments of the present disclosure;

FIG. 2A shows a detailed block diagram of an encoding system for systematic encoding of network of roads in a geographical area in accordance with some embodiments of the present disclosure;

FIG. 2B illustrates a flowchart showing a process for normalizing road data in accordance with some embodiments of the present disclosure;

FIG. 2C shows an exemplary representation of a major road for determining first limit in accordance with some embodiments of the present disclosure;

FIG. 2D represents pictorially the creeps in the network of roads in the geographical area in accordance with some embodiments of the present disclosure; and

FIG. 2E represents pictorially one or more clusters with minimum creeps in the network of roads in the geographical area in accordance with some embodiments of the present disclosure.

FIG. 2F illustrates a scenario to explain encoding in accordance with some exemplary embodiments of the present disclosure;

FIG. 3 shows a flowchart illustrating method for systematic contiguous encoding of a network of roads in a geographical area in accordance with some embodiments of the present disclosure.

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present invention provides a method and a system for systematic encoding of network of roads in a geographical area. In an embodiment, the network of roads comprises a combination of major roads and corresponding incident roads. An encoding system retrieves road data related to the network of roads from one or more data sources. As an example, the one or more data sources may include, but not limited to, a procured satellite, open databases such as image datasets, map datasets, raster datasets, vector datasets etc., systems associated with government bodies such as Municipalities, road authorities etc. Upon receiving the road data, the encoding system normalizes the road data to remove visible faults present in the road data. Further, the encoding system considers the normalized road data and divides each road in the network of roads based on one or more predefined first parameters such that each road in the network of roads adheres to a first limit. The first limit indicates predefined number of dwellings in each road in the network of roads. Further, the encoding system modifies the normalized road data with respect to the divisions of each road in the network of roads to incorporate and highlight information related to the division of each road in the network of roads. Thereafter, the encoding system groups the divided roads into one or more clusters based on one or more predefined second parameters.

Further, the encoding system identifies a major road in each of the one or more clusters and creates one or more sub-clusters from the one or more clusters until the identified major road in the network of roads and incident roads of the identified major road in the network of roads satisfy the first limit and a second limit. In an embodiment, the second limit indicates predefined number of incident roads of the identified major road in each of the one or more clusters and the one or more sub-clusters. Based on the grouping, boundaries of the one or more clusters and the one or more sub-clusters may be modified to reduce creeps occurring in the network of roads. In an embodiment the creeps are the incident roads that have possibility of belonging to the more than one major road two or more clusters and the sub-clusters.

Finally, the encoding system assigns a unique code to each of the one or more clusters and the one or more sub-clusters. Further, the encoding system assigns a unique code to the identified major road and the incident roads of the identified major road systematically in a contiguous or near contiguous manner. The systematic encoding is accurate and perfectly aligns with the practical structure of cities, towns, municipalities etc. Also, the contiguous or the near contiguous encoding helps for administrative purposes of the municipality, city planning, delivery of civil services etc. Furthermore, the systematic encoding includes providing a buffer space to accommodate dwellings, roads etc. by predicting future growth of the geographical area so that the contiguous or the near contiguous nature of the encoding does not get disturbed.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

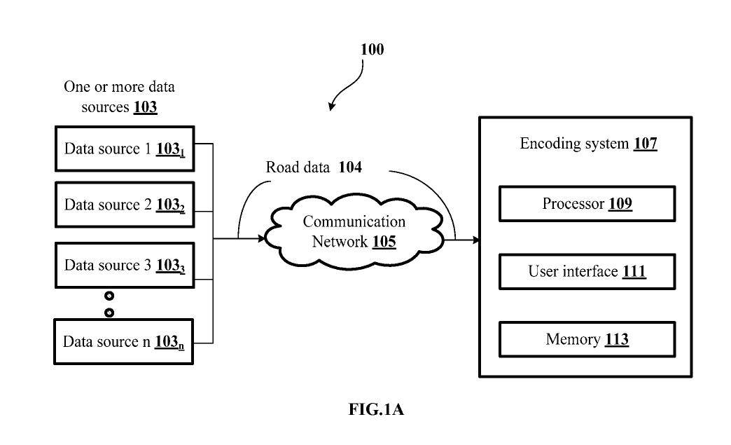

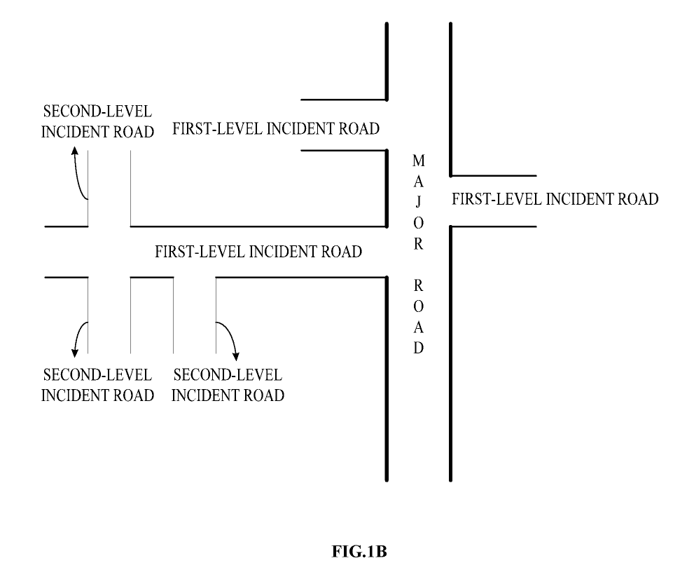

FIG. 1 shows an exemplary architecture of an encoding system for systematic encoding of network of roads in a geographical area in accordance with some embodiments of the present disclosure.

In an embodiment, the architecture 100 comprises one or more data sources, data source 1 103₁ to data source n 103ₙ (collectively referred to as one or more data sources 103), a communication network 105 and an encoding system 107. As an example, the one or more data sources 103 may include, but not limited to, a procured satellite, open databases such as image datasets, map datasets, raster datasets, vector datasets etc., systems associated with government bodies such as Municipalities, road authorities etc. In an embodiment, the one or more data sources 103 provide road data 104 related to network of roads in a given geographical area. As an example, the road data 104 may comprise images of the network of roads, maps of the network of roads, name of each road from the network of roads etc. As an example, the geographical area may be a city, a village, a state, a town etc. In an embodiment, the network of roads is formed by a combination of major roads and incident roads of the major roads. In an embodiment, the major road is a road in the network of roads which is given a high priority among other roads in the network of roads based on one or more predefined third parameters. As an example, the one or more predefined third parameters may include, but not limited to, length of the road, geographical importance of the road, historical importance of the road for the corresponding geographical area, accessibility of the road, future growth of the road based on history of the geographical area, current growth of the road, number of incident roads for the road and continuity of the road across the one or more clusters or one or more sub-clusters.

The incident roads may be of multiple levels such as first-level incident roads, second-level incident roads etc. In an embodiment, the first-level incident roads are the roads which are immediately incident to the major road and second-level incident roads are the roads incident to the first-level incident roads of the major road. Similarly, any level of incident roads may be present for a given major road. An exemplary network of roads is represented pictorially in FIG. 1B. In an embodiment, the network of roads in the geographical area may comprise one or more entities. As an example, the one or more entities may be dwellings such as a house, a building etc., a water body such as a lake, a river etc., empty spaces such as barren lands, agricultural lands etc., bridges, flyovers, landmarks etc. In an embodiment, the one or more data sources 103 communicate with the encoding system 107 through the communication network 105. As an example, the communication network 105 may be at least one of a wired communication network and a wireless communication network.

The encoding system 107 comprises a processor 109, a user interface 111 and a memory 113. The user interface 111 receives the road data 104 from the one or more data sources 103 and stores the road data 104 in the memory 113. The road data 104 may comprise faults in connections of the network of roads, duplicate roads may be indicated in the network of roads, isolated roads may be present in the network of roads, loop formations may be present in the network of roads etc. Therefore, the road data 104 cannot be directly used for encoding the network of roads. Upon receiving the road data 104, the processor 109 normalizes the road data 104. Further, the processor 109 uses the normalized road data and performs systematic and contiguous encoding of the network of roads.

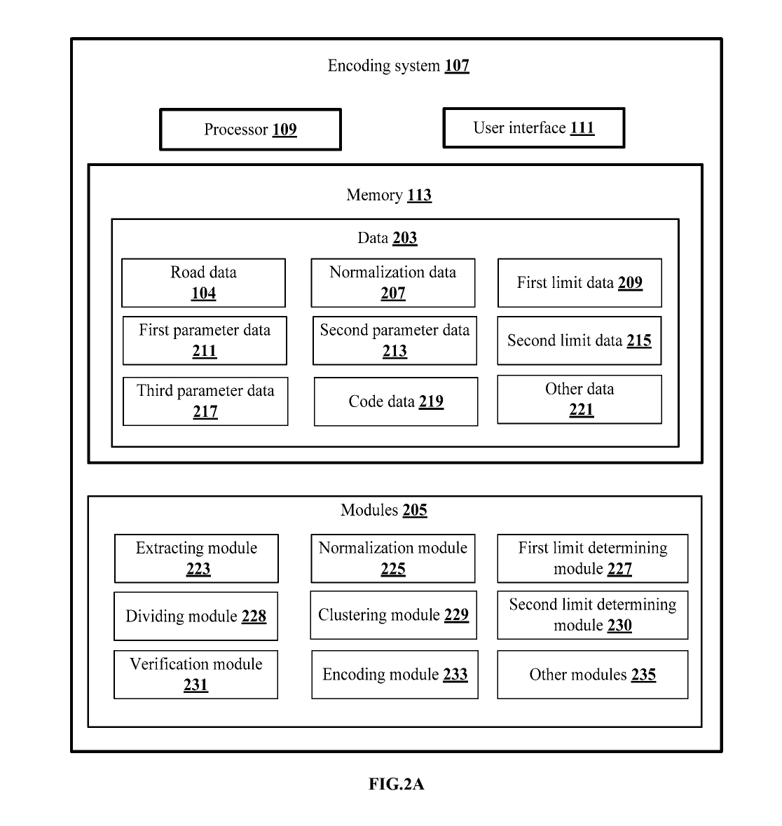

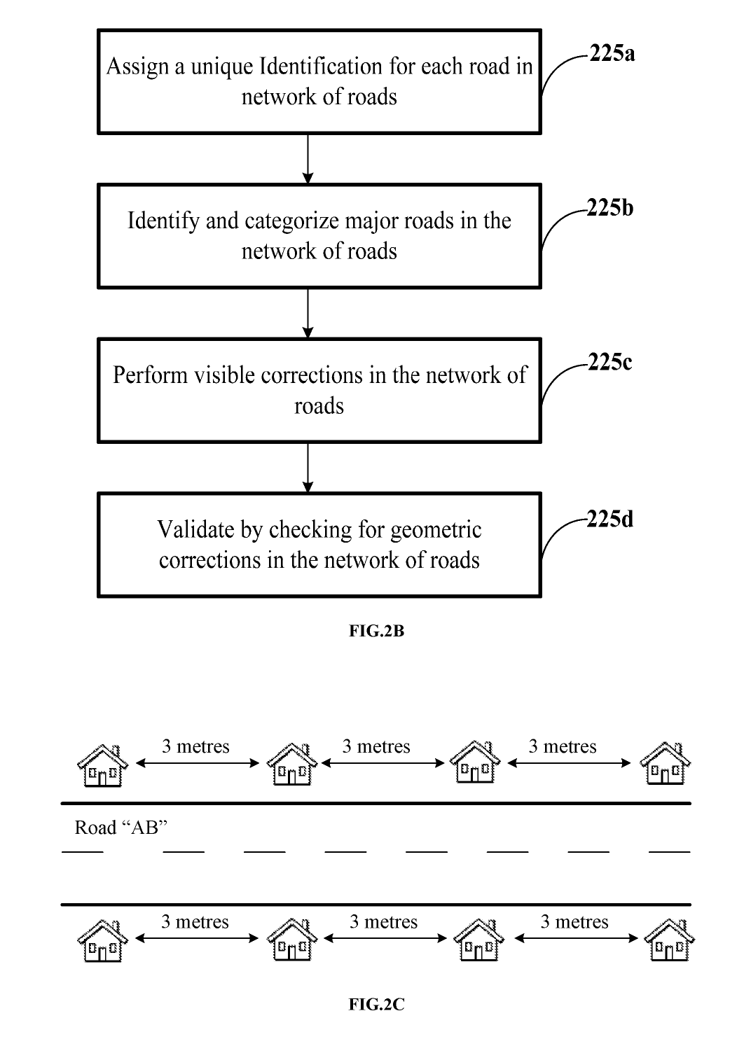

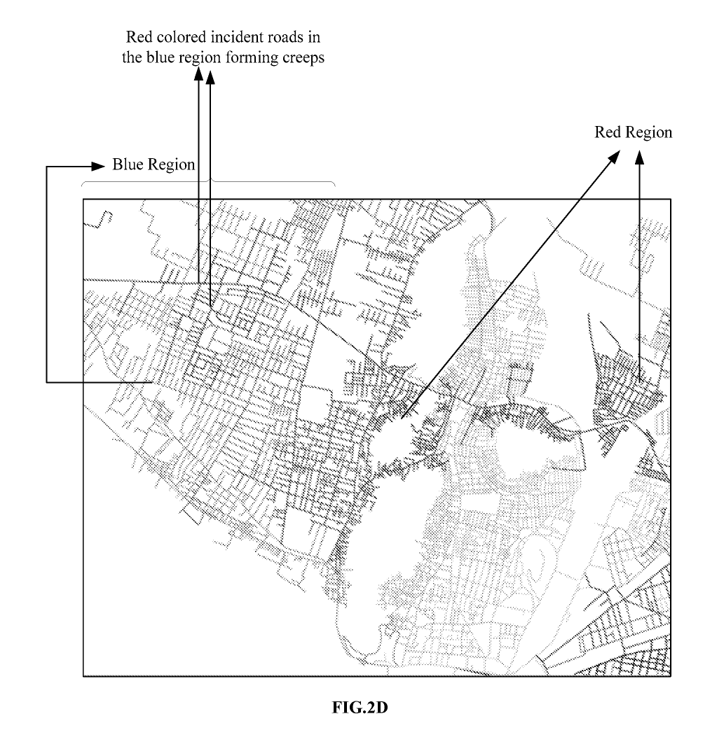

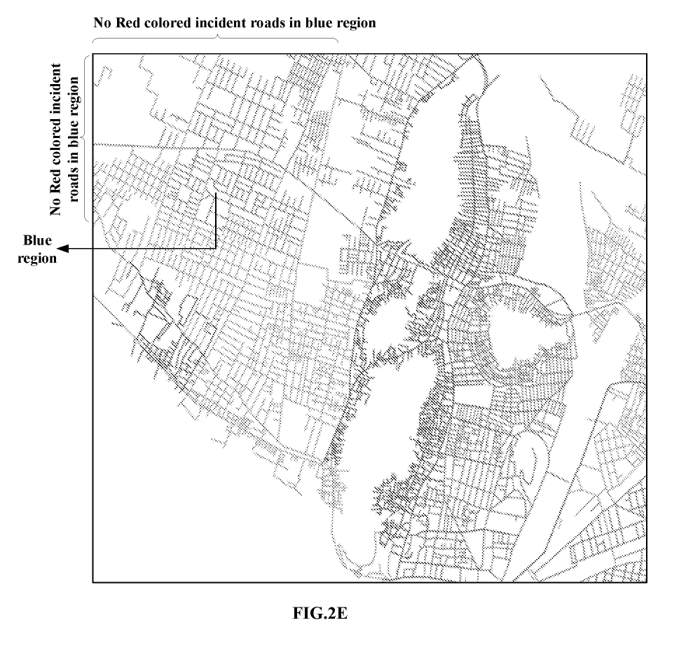

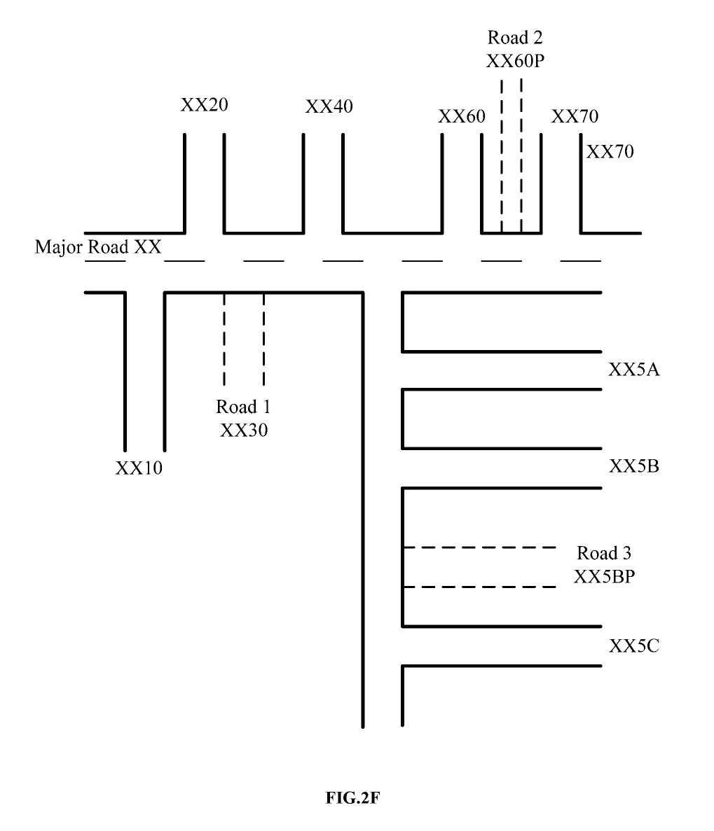

FIG. 2A shows a detailed block diagram of an encoding system for systematic encoding of network of roads in a geographical area in accordance with some embodiments of the present disclosure.

In one implementation, the encoding system 107 receives road data 104 related to network of roads in a given geographical area. As an example, the road data 104 retrieved are stored in the memory 113 configured in the encoding system 107 as shown in the FIG. 2A. In one embodiment, data 203 includes road data 104, normalization data 207, first limit data 209, first parameter data 211, second parameter data 213, second limit data 215, third parameter data 217, code data 219 and other data 221.

In one embodiment, the data may be stored in the memory 113 in the form of various data structures. Additionally, the aforementioned data can be organized using data models, such as relational or hierarchical data models. The other data 221 may store data, including temporary data and temporary files, generated by modules 205 for performing the various functions of the encoding system 107.

In an embodiment, the road data 104 may comprise images of the network of roads, maps of the network of roads, name of each road from the network of roads etc. In an embodiment, the network of roads is formed by a combination of major roads and incident roads of the major roads. The incident roads may be of multiple levels such as first-level incident roads, second-level incident roads etc.

In an embodiment, the normalization data 207 comprises one or more predefined normalization techniques to normalize the road data 104. The road data 104 needs to be normalized as the road data 104 may comprise faults in connections of the network of roads, duplicate roads may be indicated, isolated roads may be present in the network of roads, loop formations may be present in the network of roads etc.

In an embodiment, the first limit data 209 comprises a first limit that indicates predefined number of dwellings in each road in the network of roads. The first limit may be determined based on one or more predefined first techniques stored in the memory 113.

In an embodiment, the first parameter data 211 comprises one or more predefined first parameters. The one or more predefined first parameters may include, but not limited to, number of dwellings on the road, length of the road based on the dwellings on the road, a predicted value of intra-road dwelling growth, prediction of intra-road dwelling growth based on, but not limited to, history of the road, spacing of the road, age of the road and growth factor of the geographical area where the road is located.

In an embodiment, the second parameter data 213 comprises one or more predefined second parameters. The one or more predefined second parameters may include, but not limited to, structure of the geographical area, density of the geographical area based on the network of roads and dwellings on each road of the network of roads, number of major roads in each of the one or more clusters, prediction of growth of the geographical area and number of multi-level incident roads of the major road crossing over a cluster. In an embodiment, the cluster may be one of the one or more clusters or one or more sub-clusters.

In an embodiment, the second limit data 215 comprises a second limit that indicates predefined number of incident roads of the major road in each of the one or more clusters and the one or more sub-clusters. The second limit may be determined based on one or more predefined second techniques stored in the memory 113.

In an embodiment, the third parameter data 217 comprises one or more predefined third parameters. The one or more predefined third parameters may include, but not limited to, length of the road, geographical importance of the road, historical importance of the road for the corresponding geographical area, accessibility of the road, future growth of the road based on history of the geographical area, current growth of the road, number of incident roads for the road and continuity of the road across the one or more clusters or one or more sub-clusters.

In an embodiment, the code data 219 comprises unique first codes of each of the one or more clusters and each of the one or more sub-clusters, unique second code of major road in each of the one or more clusters and in each of the one or more sub-clusters, unique third code of first-level incident roads of the major road in each of the one or more clusters and in each of the one or more sub-clusters, unique fourth code to multi-level incident roads of the major road after the first-level incident roads of the major road in each of the one or more clusters and in each of the one or more sub-clusters using one or more predefined third techniques.

In an embodiment, the data stored in the memory 113 is processed by the modules 205 of the encoding system 107 as shown in FIG. 2A. The modules 205 may be stored within the memory 113. In an example, the modules 205 communicatively coupled to a processor 109 configured in the encoding system 107, may also be present outside the memory 113 as shown in FIG. 2A and implemented as hardware. As used herein, the term module refers to an application specific integrated circuit (ASIC), an electronic circuit, a processor 109 (shared, dedicated, or group) and memory 113 that execute one or more software or firmware programs, a combinational logic circuit, and/or other suitable components that provide the described functionality.

In an embodiment, the modules 205 may include, for example, an extracting module 223, a normalization module 225, a first limit determining module 227, a dividing module 228, a clustering module 229, a second limit determining module 230, a verification module 231, encoding module 233 and other modules 235. The other modules 235 may be used to perform various miscellaneous functionalities of the encoding system 107. It will be appreciated that such aforementioned modules 205 may be represented as a single module or a combination of different modules.

In an embodiment, the extracting module 223 extracts the road data 104 comprising images of the network of roads, maps of the network of roads, name of each road from the network of roads etc. from one or more data sources 103 and stores the road data 104 in the memory 113. As an example, the one or more data sources 103 may include, but not limited to, a procured satellite, open databases such as image datasets, map datasets, raster datasets, vector datasets etc., systems associated with government bodies such as Municipalities, road authorities etc.

In an embodiment, the normalization module 225 normalizes the road data 104 extracted by the extracting module 223. The normalization module 225 normalizes the road data 104 since the road data 104 may comprise faults in connections of the network of roads, duplicate roads may be indicated, isolated roads may be present in the network of roads, loop formations may be present in the network of roads etc. Therefore, the road data 104 cannot be directly used for encoding the network of roads. The process of normalization is illustrated using a flowchart as shown in FIG. 2B.

At block 225a, the normalization module 225 assigns a unique Identification (ID) for each road in the network of roads of the geographical area. As an example, consider a road having a name “church street”. The normalization module 225 may assign a unique ID such as “01” to the road with the name “church street”.

At block 225b, the normalization module 225 identifies major roads in the network of roads and categorizes the major roads. In an embodiment, the major roads are identified based on the one or more predefined third parameters. In another embodiment, along with identifying the major road based on the one or more predefined third parameters, highways may also be considered as the major roads. Further, the normalization module 225 normalizes direction of each road in the network of roads.

At block 225c, the normalization module 225 consolidates one or more corrections that are parallel, splits or merges the roads in the network of roads at each intersection of the roads to check for any disconnections, eliminates triangulated loop formations of the roads in the network of roads and establishes connection if there are any isolated roads or hanging roads in the network of roads.

At block 225d, the normalization module 225 performs validation by checking for geometric corrections of the roads in the network of roads, length of the roads in the network of roads, dangling roads in the network of roads, duplicate roads etc. and finally provides normalized road data of the geographical area to proceed with the method of systematic and contiguous encoding of the network of roads in the geographical area.

In an embodiment, the first limit determining module 227 determines the first limit based on the one or more predefined first techniques. In an embodiment, one of the one or more predefined first techniques may be determining the first limit based on the number of characters used for representing systematic and contiguous nature of encoding each road in the network of roads. As an example, the characters used for encoding may be combination of alphabets and numbers. As an example, “AA00” may be an encoding which is a combination of alphabets and numbers. Since the characters used for encoding may be a combination of alphabets and numbers, total number of possibilities to represent an encoding for each character may be 36 i.e. a combination of 26 alphabets of English language and 10 numbers.

In an embodiment, the first limit may be determined based on number of characters used for representing systematic and contiguous nature of encoding each road in the network of roads using the below given Equation 1.

First limit=m\hat{ }n Equation 1

In the above Equation 1, “m” represents number of possible encodings for each character and “n” represents the number of characters used for encoding. Lesser the value of “n”, more accurate will be the systematic and contiguous nature of encoding.

As an example, consider n is 2 and m is 36, by substituting the values in Equation 1, first limit is determined to be 1296. Therefore, any given road in the network of roads cannot have more than 1296 dwellings. If value of “n” is 1, then the first limit would be 36 which is a very small number, therefore, generally “n” is preferred to be 2 as it gives a first limit greater than 36.

In an embodiment, if there is a predefined distance between each adjacent dwelling on the road, a maximum length for each road in the network of roads is determined based on the predefined distance. As an example, the predefined distance may be varied from 1 metre to 10 metres. Further, the predefined distance may be varied based on design and planning requirements of township in the geographical area. The predefined number of dwellings in each road in the network of roads may be derived from the maximum length of each road in the network of roads. This kind of derivation may be performed since the fixed length of each road in the network of roads can mark only up to a predefined number of dwellings in each road in the network of roads.

Consider an exemplary scenario-1 as shown in FIG. 2C that illustrates the method of determining the first limit based on the number of characters used for representing systematic and contiguous nature of encoding each road in the network of roads. In the scenario-1, each dwelling on each side of the road is separated by a distance of 3 metres. Further, the scenario-1 teaches the usage of two characters for representing systematic and contiguous nature of encoding. Therefore, the total number of dwellings that can be present on each road of the network of roads in the scenario-1 may be 1296 i.e. 36*36 since two characters are used for representing systematic and contiguous nature of encoding. An exemplary encoding of a road in the scenario-1 may be “AB” where “A” is the first character and “B” is the second character. The exemplary encoding may be further represented in any of 1296 unique combinations such as “A1”, “11”, “1B” etc. Further, each dwelling on each side of the road is separated by a distance of 3 metres from an adjacent dwelling. Therefore, maximum length of each road may be determined by the below Equation 2.

Maximum length of each road=(m\hat{ }n)*distance between two adjacent dwellings/2 Equation 2

In the scenario-1, value of m\hat{ }n is 1296 and distance between two adjacent dwellings is 3 metres. Further, by substituting the values in Equation 2, maximum length of each road is determined to be 3240 metres i.e. 3 kilometres (approx.).

Since, the maximum length of each road in the scenario-1 is 3 kilometres (approx.), after every 3 kilometres, the road is considered as another road. Further, predefined number of dwellings corresponding to the maximum length of each road is determined. Therefore, in the scenario-1, though the first limit is determined to be 1296 dwellings in each road, since maximum length of each road is determined to be 3 kilometres, the number of dwellings in each road of the network of roads is decided based on the maximum length of the road but at the same time the number of dwellings in each road of the network of roads should be less than the first limit i.e. 1296 dwellings.

In an embodiment, the dividing module 228 divides each road in the network of roads based on the one or more predefined first parameters. Each road in the network of roads is divided such that each road in the network of roads adheres to the first limit. Further, the dividing module 228 modifies the normalized road data with respect to the divisions of each road in the network of roads to incorporate and highlight information related to the division of each road in the network of roads.

In an embodiment, the clustering module 229 groups the divided roads into one or more clusters based on the one or more predefined second parameters. The divided roads are grouped in such a way that the one or more clusters do not overlap. Further, the road clustering module 229 identifies a major road in each of the one or more clusters based on the one or more predefined third parameters. The clustering module 229 ensures that each of the one or more clusters comprises only one major road. Further, the clustering module 229 adjusts boundaries of the one or more clusters to avoid or minimize creeps occurring in the network of roads. In an embodiment, creeps are the incident roads that have a possibility of belonging to the two or more clusters. The creeps should be avoided or minimized as they cause confusion in the systematic and contiguous encoding. FIG. 2D represents pictorially the creeps in the network of roads. In the FIG. 2D, each color represents the major road in the network of roads and its corresponding incident roads in the corresponding cluster. As an example, all incident roads in red color indicate that they are the incident roads of the major road in red color. However, there are red colored incident roads in the middle of blue colored incident roads in the network of roads. These red colored incident roads in middle of the blue colored incident roads are the creeps formed in the network of roads which give rise to confusion. By adjusting the boundaries of the one or more clusters and the one or more the clustering module 229 eliminates or minimizes the creeps as shown in the FIG. 2E.

In an embodiment, the second limit determining module 230 determines the second limit based on the one or more predefined second techniques. In an embodiment, one of the one or more predefined second techniques may be determining the second limit based on number of characters used for encoding. As an example, the characters used for encoding may be a combination of alphabets and numbers. As an example, “AA00” may be an encoding which is a combination of alphabets and numbers. Since the characters used for encoding may be a combination of alphabets and numbers, total number of possibilities to represent an encoding for each character may be 36 i.e. a combination of 26 alphabets of English language and 10 numbers.

In an embodiment, the second limit may be determined based on number of characters used for representing systematic and contiguous nature of encoding each incident road in the network of roads using the below given Equation 3.

Second limit=m\hat{ }n Equation 3

In the above Equation 2, “m” represents number of possible encodings for each character and “n” represents the number of characters used for encoding. Lesser the value of “n”, more accurate will be the systematic and contiguous nature of encoding.

As an example, consider n is 2 and m is 36, by substituting the values in Equation 1, second limit is determined to be 1296. Therefore, the identified major road cannot have more than 1296 incident roads.

In an embodiment, the verification module 231 verifies whether the identified major road in each of the one or more clusters adheres to the second limit. Further, the verification module 231 verifies whether each of the one or more first-level incident roads of the identified major road in each of the one or more clusters also adheres to the second limit. If the verification is successful i.e. if the identified major road in each of the one or more clusters and the one or more first-level incident roads of the identified major road in each of the one or more clusters adhere to the second limit, the encoding module 233 is activated. If the verification is unsuccessful i.e. if the identified major road in each of the one or more clusters and the one or more first-level incident roads of the identified major road in each of the one or more clusters do not adhere to the second limit, the clustering module 229 performs sub-clustering of the one or more clusters to form one or more sub-clusters based on one or more predefined second parameters.

Upon forming the one or more sub-clusters, the clustering module 229 identifies the major road in each of the one or more sub-clusters based on the one or more predefined third parameters. The clustering module 229 ensures that each of the one or more sub-clusters do not overlap and comprises not more than one major road. Further, the verification module 231 verifies if the identified major road in each of the one or more sub-clusters adheres to the second limit. Furthermore, the verification module 231 verifies if each of the first-level incident roads of the identified major road in each of the one or more sub-clusters adheres to the second limit. If the verification is successful, i.e. if the identified major road in each of the one or more sub-clusters and the one or more first-level incident roads of the identified major road in each of the one or more sub-clusters adhere to the second limit, the encoding module 235 is activated. If the verification is unsuccessful i.e. if the identified major road in each of the one or more sub-clusters and the one or more first-level incident roads of the identified major road in each of the one or more sub-clusters do not adhere to the second limit, the clustering module 229 performs further sub-clustering of the one or more sub-clusters. In an embodiment, the clustering module 229 continues to perform sub-clustering until the verification is determined to be successful by the verification module 231 and further activates the encoding module 233. In an embodiment, the verification module 231 may also verify whether each road in the network of roads adheres to the second limit. The process of whether the verification is successful or unsuccessful is as per the above explanation.

In an embodiment, the encoding module 233 performs systematic contiguous encoding of each of the one or more clusters and each of the one or more sub-clusters, the identified major road in each of the one or more clusters and in each of the one or more sub-clusters and the incident roads of the identified major road in each of the one or more clusters and in each of the one or more sub-clusters. Firstly, the encoding module 233 assigns a unique first code to each of the one or more clusters and each of the one or more sub-clusters consecutively based on one or more predefined conditions. In an embodiment, one of the one or more predefined conditions may be selecting a direction by the encoding module 233 to start assigning the unique first codes. In an embodiment, the directions may include, but not limited to, “North”, “South”, “East” and “West”. The encoding module 233 assigns a unique first code to first cluster of the one or more clusters and the one or more sub-clusters encountered first at the selected direction. Further, another predefined condition of the one or more predefined conditions may be to check if the first cluster of the one or more clusters and the one or more sub-clusters shares a common major road with a neighbouring cluster of the one or more clusters and the one or more sub-clusters. In an embodiment, the common major road is defined as a road continuing across one or more clusters and one or more sub-clusters which is identified as the major road in those one or more clusters and the one or more sub-clusters.

If the common major road exists, then the encoding module 233 assigns the unique first codes consecutively to each of the one or more clusters and the one or more sub-clusters in the direction of neighbouring cluster of the one or more clusters and the one or more sub-clusters. Yet another predefined condition of the one or more predefined conditions is that, if the common major road does not exist between the first cluster and the neighbouring cluster of the one or more clusters and the one or more sub-clusters, the encoding module 233 assigns the consecutive unique first code to each of the one or more clusters and the one or more sub-clusters in clockwise direction from the first cluster of the one or more clusters and the one or more sub-clusters.

Upon assigning the unique first code to each of the one or more clusters and the one or more sub-clusters, the encoding module 233 assigns a unique second code to the identified major road in each of the one or more clusters and the one or more sub-clusters. The encoding module 233 assigns the unique second code to the identified major road in each of the one or more clusters and the one or more sub-clusters in the same direction that was considered for assigning the unique first code to each of the one or more clusters and the one or more sub-clusters.

Upon assigning the unique second code to the identified major road in each of the one or more clusters and the one or more sub-clusters, the encoding module 233 assigns a unique third code to the first-level incident roads of the identified major road in each of the one or more clusters and in each of the one or more sub-clusters from a predefined direction. As an example, if the predefined direction is “West”, the encoding module 233 starts assigning the unique third code to the first-level incident roads of the identified major road of the one or more clusters and the one or more sub-clusters from West direction. The encoding module 233 assigns the unique third code to all the first-level incident roads of the identified major road in each of the one or more clusters and in each of the one or more sub-clusters contiguously in a horizontal manner.

Upon assigning the unique third code to the first-level incident roads of the identified major road in each of the one or more clusters and in each of the one or more sub-clusters, the encoding module 233 assigns a unique fourth code to multi-level incident roads of the identified major road in each of the one or more clusters and in each of the one or more sub-clusters. The unique fourth code is assigned to the multi-level incident roads after the first-level incident roads of the identified major road in each of the one or more clusters and in each of the one or more sub-clusters using one or more predefined third techniques. As an example, the one or more predefined third techniques may include, but not limited to a Depth-First Search (DFS) technique and the Breadth First Search (BFS) technique. In an embodiment, the DFS technique is used when vertically (depth wise) the multi-level incident roads of the identified major road of the one or more clusters and the one or more sub-clusters are greater than the multi-level incident roads of the identified major road of the one or more clusters and the one or more sub-clusters present horizontally (breadth wise) at the respective level. As an example, consider the second-level incident roads for a major road. If the depth of the multi-level incident roads from the second-level onwards is greater than the breadth of the second-level incident roads i.e. number of second-level incident roads, then DFS technique is used for encoding the multi-level incident roads. In another embodiment, the BFS technique is used when vertically (depth wise) the multi-level incident roads are less than the multi-level incident roads present horizontally (breadth wise) at the respective level.

Considering the above mentioned example, if the depth of the multi-level incident roads from the second-level onwards is less than the breadth of the second-level incident roads i.e. number of second-level incident roads, then the BFS technique is used for encoding the multi-level incident roads. In another embodiment, it could be a pattern of the DFS technique at one level of the incident roads and the BFS technique at next level of the incident roads. At each level of the incident roads of the identified major road of each of the one or more clusters and the one or more sub-clusters, the encoding module 233 decides which of the one or more predefined third techniques should be used.

Consider an exemplary encoding 0100AAB5 considering that two characters are used for representing systematic and contiguous nature of encoding. Therefore, in the exemplary encoding, the first two characters “01” represent one of the one or more clusters and the one or more sub-clusters. Further, including the next two characters, “00” represents the major road. Furthermore, including the next two characters, “0100AA” represents a dwelling on the major road. Finally, including the last two characters, “0100AAB5” represents a segment inside the dwelling such as an apartment in ground floor of the dwelling may be one segment of the dwelling, another apartment in first floor of the dwelling may be another segment of the dwelling etc. Further, as an example, consider a major road represented by a unique second code “0100”. In this scenario, the first-level incident roads of the major road “0100 may be “0110”, “0120”, “0130”, “0140” etc. Furthermore, as an example, if the major road is represented by another unique second code “AA00”, then the first-level incident roads of the major road “AA00” may be “AA10”, “AA20”, “AA30” etc. As an example, a dwelling in the first-level incident road “AA10” may be represented as “AA1001”, “AA1002”, “AA1003” etc. Further, to illustrate encoding of a multi-level incident road, consider the multi-level incident road of a major road “AA00” which is connected through a first-level incident road “AA30” with a code AA3C0502. The first three characters represent that the multi-level incident road belongs to the cluster “AA”, the major road “AA00” and the first-level incident road “AA30”. Based on the DFS technique, the BFS technique or a pattern of the DFS technique at one level of the incident roads and the BFS technique at next level of the incident roads, “AA3C” represents a multi-level incident road of the first-level incident road “AA30”. Further, the next two characters “05” in “AA3C05” represent a dwelling/building on the multi-level incident road “AA3C” and the last two characters “02” in “AA3C0502” represent a segment inside the dwelling such as an apartment in ground floor of the dwelling may be one segment of the dwelling, another apartment in first floor of the dwelling may be another segment of the dwelling etc.

Further, the encoding module 233 ensures that each of the unique second codes are separated by predefined number of major roads anticipated in each of the one or more clusters and in each of the one or more sub-clusters. Also, the encoding module 233 ensures that each of the unique third codes are separated by predefined number of first-level incident roads anticipated for each of the identified major road in each of the one or more clusters and in each of the one or more sub-clusters. Furthermore, the encoding module 233 ensures that each of the unique fourth codes are separated by a predefined number of multi-level incident roads anticipated for each first-level incident road of the identified major road in each of the one or more clusters and in each of the one or more sub-clusters.

Consider a scenario-2 as shown in FIG. 2F that indicates three missing incident roads or three new incident roads. In the scenario-2, consider that the road represented by a unique second code “XX” is the identified major road in a cluster. Roads represented by unique third codes “XX10”, “XX20”, “XX40”, “XX50”, “XX60” and “XX70” are first-level incident roads of the identified major road “XX” in the cluster. Further, roads represented by unique fourth codes “XX5A”, “XX5B” and “XX5C” are multi-level incident roads of the identified major road “XX” in the cluster.

Road 1 represented in the FIG. 2F is a new incident road that is added to the network of roads. Road 1 lies between the first-level incident roads “XX20” and “XX40”. The encoding module 233 ensures that each of the first-level incident roads are separated by the predefined number of first-level incident roads anticipated for each of the identified major road in each of the one or more clusters and each of the one or more sub-clusters to maintain continuity in the encoding process. The encoding module 233 predicted that a road could be laid in future between the first-level incident road “XX20” and the first-level incident road “XX40”. Therefore, the encoding module 233 left a buffer space for the anticipated road i.e. instead of assigning “XX30” after “XX20”, the encoding module 233 assigned “XX40” instead. Therefore, the newly added first-level incident road lying between the first-level incident roads “XX20” and “XX40” is represented by a unique third code “XX30” thereby, maintaining the continuity in encoding.

Further, Road 2 is a first-level incident road that was missing in the initial road data and was not anticipated to exist between the first-level incident roads “XX60” and “XX70”. Therefore, in such a case, the unique third code is assigned to Road 2 by adding a new character. As an example, the Road 2 existing between the first-level incident roads “XX60” and “XX70” is given the unique third code “XX60P”. By providing the unique third code “XX60P” to the Road 2, we are in turn reserving from “XX60A-XX60O” and “XX600-XX609” between the first-level incident road “XX60” and Road 2 “XX60P” for future use such that contiguous and systematic encoding can be ensured. Similarly, a unique fourth code “XX5BP” is assigned to the third-level (multi-level) incident road that lies between “XX5B” and “XX5C”.

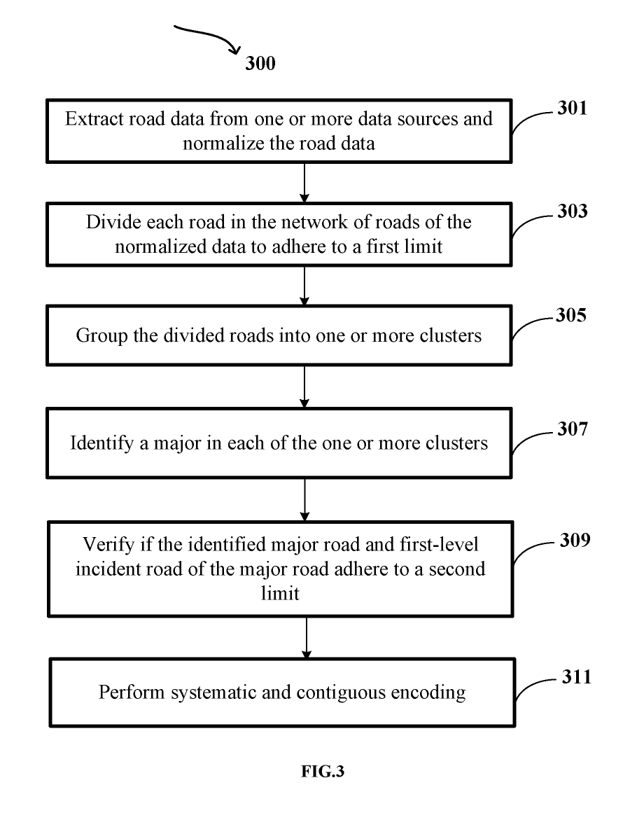

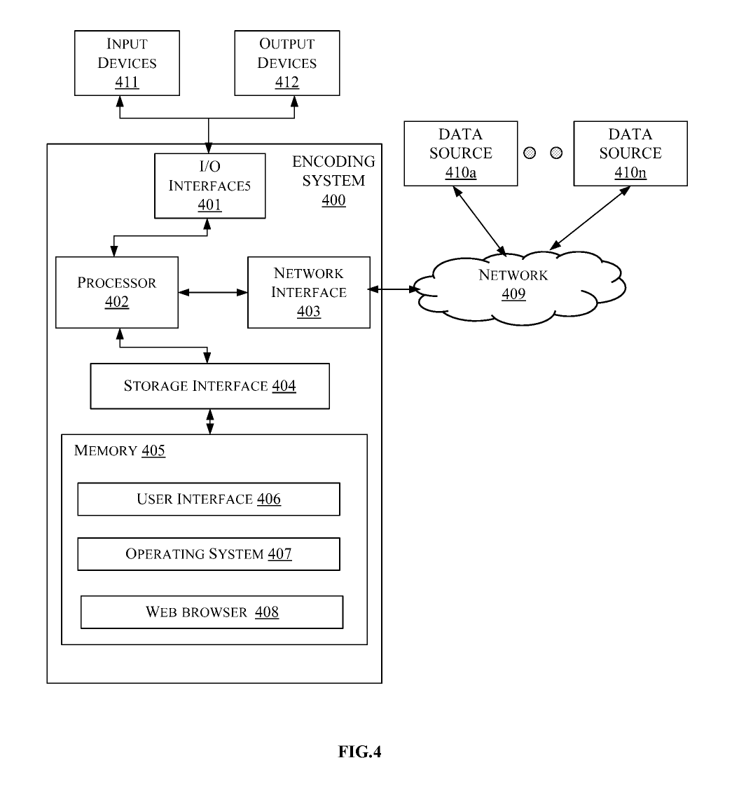

FIG. 3 shows a flowchart illustrating method for systematic contiguous encoding of a network of roads in a geographical area in accordance with some embodiments of the present disclosure.

As illustrated in FIG. 3, the method 300 comprises one or more blocks illustrating a method for systematic contiguous encoding of a network of roads in a geographical area. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, road data 104 is extracted and normalized by an encoding system 107. In an embodiment, a processor 109 of the encoding system 107 extracts the road data 104 from one or more data sources 103 and stores the road data 104 in a memory 113 of the encoding system 107. Further, the processor 109 normalizes the road data 104 extracted by the extracting module 223. The processor 109 normalizes the road data 104 to eliminate faults that the road data 104 may comprise such as faults in connections of the network of roads, duplicate roads may be indicated, isolated roads may be present in the network of roads, loop formations may be present in the network of roads etc.

At block 303, each road in the network of roads of the normalized road data 104 is divided by the encoding system 107. In an embodiment, each road in the network of roads is divided based on one or more predefined first parameters such that each road in the network of roads adheres to a first limit. The first limit indicates predefined number of dwellings in each road in the network of roads and is determined based on one or more predefined first techniques. Further, the processor 109 modifies the normalized road data with respect to the divisions of each road in the network of roads to incorporate and highlight information related to the division of each road in the network of roads.

At block 305, the divided roads are grouped into one or more clusters by the encoding system 107. In an embodiment, the processor 109 groups the divided roads into one or more clusters based on the one or more predefined second parameters. The divided roads are grouped in such a way that the one or more clusters do not overlap.

At block 307, a major road is identified in each of the one or more clusters by the encoding system 107. In an embodiment, the processor 109 identifies the major road in each of the one or more clusters based on the one or more predefined third parameters. The processor 109 ensures that each of the one or more clusters comprises only one major road. Further, the processor 109 adjusts boundaries of the one or more clusters to avoid or minimize creeps occurring in the network of roads. In an embodiment, creeps are the incident roads that have a possibility of belonging to the two or more clusters. The creeps should be avoided or minimized as they cause confusion in the systematic and contiguous encoding.

At block 309, verification is performed by the encoding system 107. In an embodiment, the processor 109 verifies whether the identified major road in each of the one or more clusters adheres to a second limit. The second limit indicates predefined number of incident roads of the identified major road in each of the one or more clusters and is determined based on the one or more predefined second techniques. Further, the processor 109 verifies whether each of the one or more first-level incident roads of the identified major road in each of the one or more clusters also adheres to the second limit. If the verification is successful i.e. if the identified major road in each of the one or more clusters and the one or more first-level incident roads of the identified major road in each of the one or more clusters adhere to the second limit, the processor 109 starts the process of encoding. If the verification is unsuccessful i.e. if the identified major road in each of the one or more clusters and the one or more first-level incident roads of the identified major road in each of the one or more clusters do not adhere to the second limit, the processor 109 performs sub-clustering of the one or more clusters to form one or more sub-clusters based on one or more predefined second parameters and verifies the one or more sub-clusters. The processor 109 continues to perform sub-clustering until the verification is successful and then starts the process of encoding.

At block 311, systematic and contiguous encoding is performed by the encoding system 107. In an embodiment, the processor 109 performs systematic contiguous encoding of each of the one or more clusters and each of the one or more sub-clusters, the identified major road in each of the one or more clusters and in each of the one or more sub-clusters and the incident roads of the identified major road in each of the one or more clusters and in each of the one or more sub-clusters. Firstly, the processor 109 assigns a unique first code to each of the one or more clusters and each of the one or more sub-clusters consecutively based on one or more predefined conditions. Upon assigning the unique first code to each of the one or more clusters and the one or more sub-clusters, the processor 109 assigns a unique second code to the identified major road in each of the one or more clusters and the one or more sub-clusters. The processor 109 assigns the unique second code to the identified major road in each of the one or more clusters and the one or more sub-clusters in the same direction that was considered for assigning the unique first code to each of the one or more clusters and the one or more sub-clusters. Upon assigning the unique second code to the identified major road in each of the one or more clusters and the one or more sub-clusters, the processor 109 assigns a unique third code to the first-level incident roads of the identified major road in each of the one or more clusters and in each of the one or more sub-clusters from a predefined direction. Upon assigning the unique third code to the first-level incident roads of the identified major road in each of the one or more clusters and in each of the one or more sub-clusters, the processor 109 assigns a unique fourth code to multi-level incident roads of the identified major road in each of the one or more clusters and in each of the one or more sub-clusters. The unique fourth code is assigned to the multi-level incident roads after the first-level incident roads of the identified major road in each of the one or more clusters and in each of the one or more sub-clusters using one or more predefined third techniques.

FIG. 4 is a block diagram of an exemplary computer system for implementing embodiments consistent with the present disclosure.

In an embodiment, the encoding system 400 is used for systematic contiguous encoding of a network of roads in a geographical area. The encoding system 400 may comprise a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the encoding system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the encoding system 400 may communicate with one or more data sources 410 (a, . . . ,n). The communication network 409 can be implemented as one of the different types of networks, such as intranet or Local Area Network (LAN) and such within the organization.

The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more data sources 410 (a, . . . ,n) may include, the one or more data sources 103 may include, but not limited to, a procured satellite, open databases such as image datasets, map datasets, raster datasets, vector datasets etc., systems associated with government bodies such as Municipalities, road authorities etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface application 406, an operating system 407, web server 408 etc. In some embodiments, encoding system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the encoding system 400. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the encoding system 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the encoding system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the encoding system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the encoding system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

### Advantages of the Present Disclosure

The present disclosure provides a method and a system for systematic encoding of network of roads in a geographical area.

The present disclosure discloses systematic encoding for the network of roads which is accurate and perfectly aligns with the practical structure of cities, towns, municipalities etc.

The present disclosure provides a feature wherein the major roads along with the incident roads are encoded contiguously that helps for administrative purpose of the municipalities, city planning, delivery of civil services etc.

The present disclosure provides a feature wherein the systematic encoding provides a buffer space to accommodate dwellings, roads etc. by predicting future growth of the geographical area so that the contiguous or the near contiguous nature of the encoding does not get disturbed.

The present disclosure provides a feature wherein creeps in the network of roads are avoided or minimized to a large extent.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for systematic contiguous encoding of a network of roads in a geographical area. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

Referral numerals

| Reference Number | Description |
|---|---|
| 100 | Architecture |
| 103 | One or more data sources |
| 104 | Road data |
| 105 | Communication network |
| 107 | Encoding system |
| 109 | Processor |
| 111 | User interface |
| 113 | Memory |
| 203 | Data |
| 205 | Modules |
| 207 | Normalization data |
| 209 | First limit data |
| 211 | First parameter data |
| 213 | Second parameter data |
| 215 | Second limit data |
| 217 | Third parameter data |
| 219 | Code data |
| 221 | Other data |
| 223 | Extracting module |
| 225 | Normalization module |
| 227 | First limit determining module |
| 228 | dividing module |
| 229 | clustering module |
| 230 | Second limit determining module |
| 231 | Verification module |
| 233 | Encoding module |
| 235 | Other modules |

1. A method for systematic contiguous encoding of a network of roads in a geographical area, the method comprises:
extracting, by an encoding system, road data related to the network of roads from one or more data sources, wherein the road data is normalized by the encoding system;
dividing, by the encoding system, each road in the network of roads based on one or more predefined first parameters such that each road in the network of roads adheres to a first limit determined using one or more predefined first techniques, wherein the first limit indicates predefined number of dwellings in each road in the network of roads;
grouping, by the encoding system, the divided roads into one or more clusters based on one or more predefined second parameters, such that the one or more clusters do not overlap, wherein the encoding system modifies boundaries of the one or more clusters to reduce creeps occurring in the network of roads;
identifying, by the encoding system, a major road in each of the one or more clusters based on one or more predefined third parameters, wherein each of the one or more clusters comprises not more than one major road;
verifying, by the encoding system, adherence of:
the identified major road in each of the one or more clusters to a second limit determined using one or more predefined second techniques, wherein the second limit indicates predefined number of incident roads of the identified major road in each of the one or more clusters; and
each of first-level incident roads of the identified major road in each of the one or more clusters to the second limit; and
performing, by the encoding system, the systematic contiguous encoding of each of the one or more clusters, the identified major road in each of the one or more clusters and the incident roads of the identified major road in each of the one or more clusters, if the verification is successful.

2. The method as claimed in claim 1 further comprises:
dividing, by the encoding system, the one or more clusters into one or more sub-clusters if the verification is unsuccessful, wherein the encoding system modifies boundaries of the one or more sub-clusters to reduce the creeps occurring in the network of roads;
identifying, by the encoding system, a major road in each of the one or more sub-clusters based on the one or more predefined third parameters, wherein each of the one or more sub-clusters comprises not more than one major road; and
performing, by the encoding system, the systematic contiguous encoding of each of the one or more sub-clusters, the identified major road in each of the one or more sub-clusters and incident roads of the identified major road in each of the one or more sub-clusters.

3. The method as claimed in claim 2 further comprises dividing the one or more sub-clusters until:
a major road in the divided one or more sub-clusters adheres to the second limit; and
each of first-level incident roads of the identified major road in the divided one or more sub-clusters adhere to the second limit.

4. The method as claimed in claim 1, wherein the network of roads comprises a combination of the major roads and the incident roads of the major roads.

5. The method as claimed in claim 1, wherein the systematic contiguous encoding comprises:
assigning, by the encoding system, a unique first code to each of the one or more clusters and each of the one or more sub-clusters consecutively based on one or more predefined conditions;
assigning, by the encoding system, a unique second code to the major road in each of the one or more clusters and in each of the one or more sub-clusters;
assigning, by the encoding system, a unique third code to the first-level incident roads of the identified major road in each of the one or more clusters and in each of the one or more sub-clusters; and
assigning, by the encoding system, a unique fourth code to multi-level incident roads of the identified major road after the first-level incident roads of the identified major road in each of the one or more clusters and in each of the one or more sub-clusters using one or more predefined third techniques.

6. The method as claimed in claim 5, wherein each of the unique second codes are separated by predefined number of major roads anticipated, each of the unique third codes are separated by predefined number of first-level incident roads anticipated for each of the identified major road and each of the unique fourth codes are separated by a predefined number of multi-level incident roads anticipated for each first-level incident road of the identified major road in each of the one or more clusters and in each of the one or more sub-clusters.

7. The method as claimed in claim 1, wherein the creeps are the incident roads that have possibility of belonging to the two or more clusters and the sub-clusters.

8. An encoding system for systematic contiguous encoding of a network of roads in a geographical area, the encoding system comprising:
a processor; and
a memory communicatively coupled to the processor, wherein the memory stores the processor-executable instructions, which, on execution, causes the processor to:
extract road data related to the network of roads from one or more data sources, wherein the road data is normalized by the encoding system;
divide each road in the network of roads based on one or more predefined first parameters such that each road in the network of roads adheres to a first limit determined using one or more predefined first techniques, wherein the first limit indicates predefined number of dwellings in each road in the network of roads;
group the divided roads into one or more clusters based on one or more predefined second parameters, such that the one or more clusters do not overlap, wherein the processor modifies boundaries of the one or more clusters to reduce creeps occurring in the network of roads;
identify a major road in each of the one or more clusters based on one or more predefined third parameters, wherein each of the one or more clusters comprises not more than one major road;
verify adherence of:
the identified major road in each of the one or more clusters to a second limit determined using one or more predefined second techniques, wherein the second limit indicates predefined number of incident roads of the identified major road in each of the one or more clusters; and
each of first-level incident roads of the identified major road in each of the one or more clusters to the second limit; and
perform the systematic contiguous encoding of each of the one or more clusters, the identified major road in each of the one or more clusters and the incident roads of the identified major road in each of the one or more clusters, if the verification is successful.

9. The encoding system as claimed in claim 8, wherein the processor is further configured to:
divide the one or more clusters into one or more sub-clusters if the verification is unsuccessful, wherein the processor modifies boundaries of the one or more sub-clusters to reduce the creeps occurring in the network of roads;
identify a major road in each of the one or more sub-clusters based on the one or more predefined third parameters, wherein each of the one or more sub-clusters comprises not more than one major road; and
perform the systematic contiguous encoding of each of the one or more sub-clusters, the identified major road in each of the one or more sub-clusters and incident roads of the identified major road in each of the one or more sub-clusters.

10. The encoding system as claimed in claim 9, wherein the processor divides the one or more sub-clusters until:
a major road in the divided one or more sub-clusters adheres to the second limit; and
each of first-level incident roads of the identified major road in the divided one or more sub-clusters adhere to the second limit.

11. The encoding system as claimed in claim 8, wherein the network of roads comprises a combination of the major roads and the incident roads of the major roads.

12. The encoding system as claimed in claim 8, wherein the processor performs the systematic contiguous encoding by:
assigning a unique first code to each of the one or more clusters and each of the one or more sub-clusters consecutively based on one or more predefined conditions;
assigning a unique second code to the major road in each of the one or more clusters and in each of the one or more sub-clusters;
assigning a unique third code to the first-level incident roads of the identified major road in each of the one or more clusters and in each of the one or more sub-clusters; and
assigning unique fourth code to multi-level incident roads of the identified major road after the first-level incident roads of the identified major road in each of the one or more clusters and in each of the one or more sub-clusters using one or more predefined third techniques.

13. The encoding system as claimed in claim 12, wherein each of the unique second codes are separated by predefined number of major roads anticipated, each of the unique third codes are separated by predefined number of first-level incident roads anticipated for each of the identified major road and each of the unique fourth codes are separated by a predefined number of multi-level incident roads anticipated for each first-level incident road of the identified major road in each of the one or more clusters and in each of the one or more sub-clusters.

14. The encoding system as claimed in claim 8, wherein the creeps are the incident roads that have possibility of belonging to the two or more clusters and the sub-clusters.

15. The method as claimed in claim 2, wherein the systematic contiguous encoding comprises:
assigning, by the encoding system, a unique first code to each of the one or more clusters and each of the one or more sub-clusters consecutively based on one or more predefined conditions;
assigning, by the encoding system, a unique second code to the major road in each of the one or more clusters and in each of the one or more sub-clusters;
assigning, by the encoding system, a unique third code to the first-level incident roads of the identified major road in each of the one or more clusters and in each of the one or more sub-clusters; and
assigning, by the encoding system, a unique fourth code to multi-level incident roads of the identified major road after the first-level incident roads of the identified major road in each of the one or more clusters and in each of the one or more sub-clusters using one or more predefined third techniques.

16. The method as claimed in claim 15, wherein each of the unique second codes are separated by predefined number of major roads anticipated, each of the unique third codes are separated by predefined number of first-level incident roads anticipated for each of the identified major road and each of the unique fourth codes are separated by a predefined number of multi-level incident roads anticipated for each first-level incident road of the identified major road in each of the one or more clusters and in each of the one or more sub-clusters.

17. The encoding system as claimed in claim 9, wherein the processor performs the systematic contiguous encoding by:
assigning a unique first code to each of the one or more clusters and each of the one or more sub-clusters consecutively based on one or more predefined conditions;
assigning a unique second code to the major road in each of the one or more clusters and in each of the one or more sub-clusters;
assigning a unique third code to the first-level incident roads of the identified major road in each of the one or more clusters and in each of the one or more sub-clusters; and
assigning unique fourth code to multi-level incident roads of the identified major road after the first-level incident roads of the identified major road in each of the one or more clusters and in each of the one or more sub-clusters using one or more predefined third techniques.

18. The encoding system as claimed in claim 17, wherein each of the unique second codes are separated by predefined number of major roads anticipated, each of the unique third codes are separated by predefined number of first-level incident roads anticipated for each of the identified major road and each of the unique fourth codes are separated by a predefined number of multi-level incident roads anticipated for each first-level incident road of the identified major road in each of the one or more clusters and in each of the one or more sub-clusters.
